(19) United States
(12) Patent Application Publication
(10) Pub. No.: US 2008/0230002 A1
(43) Pub. Date: Sep. 25, 2008

(54) Sealer Gun

(75) Inventors: Koutarou Hirata, Mie (JP); Souichi Kokubu, Mie (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 10/597,264

(22) PCT Filed: Jan. 14, 2005
(86) PCT No.: PCT/JP2005/000383

§ 371 Date: Aug. 9, 2006

(30) Foreign Application Priority Data
Jan. 19, 2004 (JP) 2004-010394
Jan. 13, 2005 (JP) 2005-006134

(51) Int. Cl. B05C 5/00

(52) U.S. Cl. 118/300; 222/402.14

(57) ABSTRACT

The object of the present invention is to provide a sealer gun in which even an operator having no expert skill can easily conduct application by optionally setting the bead width, and keep the application uniform from the initial stage to the final stage. In the sealer gun, the needle valve is moved backward by predetermined strokes by operating the trigger, and a sealer is spouted from the gap between the valve seat and the needle valve. In this instance, with the adjusting knob of the notch portion provided in the base portion of the gun body, the position-adjusting member is moved back and forth, and the moving-backward stroke of the needle valve is controlled. The tapered portion 8b is formed at the tip of the needle valve, and the orifice member is provided in the sealer passage in the downstream of the valve seat so as to absorb the pulsating pressure variation of the sealer.

### TECHNICAL FIELD

The present invention relates to a sealer gun for applying a viscous material such as a sealing material or a tackiness agent in which a bead width (application width) can be set optionally and uniform application can be achieved.

### BACKGROUND ART

Conventionally, a sealer is applied to a joint section of, for example, a panel for a vehicle so as to keep airtight and watertight properties and prevent rusting at the same time. In operation, while a sealer stored in a tank or the like is introduced to a sealer gun by a pumping means such as a pump, a needle valve of the sealer gun is moved backward by a trigger operation so as to form a gap between the needle valve and the valve seat, and thereby the sealer is spouted from the gap. The sealer is applied to an object in a bead state by moving the sealer gun. In the sealer gun, there is a difference between the initial spout amount at the time of starting the application of the sealing material and the spout amount in a stable state after a certain period of time has passed. Generally, the initial spout amount is large because the spout pressure acts in a dramatic manner, and the sealer is applied in a ball shape which deteriorates the appearance (which is referred to as “spit”). Therefore, in order to conduct uniform application, it is necessary to reduce the degree of the trigger operation at the initial stage of the application, and gradually increase the degree of the trigger operation. However, it is extremely difficult for even an expert to apply a uniform amount by adjusting the degree of the trigger operation in the course of the application.

Therefore, there has been known a technique in which the portion of a valve body for adjusting the flow rate inserted into a valve hole of a valve seat is made in a conic shape, and when the valve body is moved backward and drawn from the valve hole, the flow rate of the sealer is gradually increased corresponding to the amount of movement of the valve body (See Document 1). There has been known another technique in which a stepped portion having a smaller diameter is provided in the back end of a needle valve, a spherical body, which is advanced by a spring, is provided in a state of being pushed onto the back end of the needle valve, and the movement of the needle valve is controlled by the stepped portion so as to allow a spout port of a nozzle to be half-opened at the initial stage of the application and thereby control an increase of the spout amount (See Document 2).

In addition, there has been known another technique in which a spit is prevented by providing a depressurizing mechanism in a sealer passage and also by controlling the moving velocity of the sealer gun (application speed).
[Document 1] Japanese Utility Model Application Publication No. 63-141676
[Document 2] Japanese Utility Model No. 2583411

### DISCLOSURE OF THE INVENTION

### Problems to be Solved by the Invention

However, the feature of the technique described in Document 1 is merely in that the portion of the valve body for adjusting the flow rate inserted into the valve hole of the valve seat is made in a conic shape. Therefore, it is still necessary for an operator to keep the degree of the trigger operation uniform all the time in order to keep the bead width uniform in a certain spout amount, and consequently expert skill is required. Also, if the bead width needs to be changed, it becomes necessary to slightly adjust the degree of the trigger operation by hand, and this also requires expert skill. Although there is a method for adjusting the flow rate with a flow-rate adjusting valve, if the distance between the valve and the gun is long, the adjustment of the flow rate corresponding to the bead width is complicated, and there is a strong likelihood that the bead width is non-uniform.

Also, in Document 2, the flow rate cannot be controlled. Therefore, if the bead width needs to be changed, it is necessary to adjust the flow rate with a flow-rate adjusting valve. Therefore, in the case where the distance between the valve and the gun is long, the adjustment of the flow rate corresponding to the bead width is complicated, and there is a strong likelihood that the bead width is non-uniform. In addition, although the bead width can be changed by adjusting the moving velocity of the sealer gun in a state where the flow rate is kept uniform, there is still a drawback that expert skill is needed.

The object of the present invention is to provide a sealer gun in which even an operator having no expert skill can easily conduct application by optionally setting the bead width, and keep the application uniform from the initial stage to the final stage.

### Means for Solving the Problems

To solve the above-mentioned problems, according to the present invention, there is provided a sealer gun comprising a trigger, a needle valve, and a valve seat, wherein the needle valve is moved backward by predetermined strokes by operating the trigger so as to form a gap between the valve seat and the needle valve, so that a sealer is spouted from the gap, and wherein the sealer gun further comprises a controlling member for controlling the moving-backward stroke of the needle valve in a regulated manner and a tapered potion having a tapered end which is provided at the tip of the needle valve.

With the provision of the tapered portion, it is possible to control a drastic increase of the spout amount at the time of starting to pull the trigger. In addition, as the number of the moving-backward stroke increases, the gap between the valve seat and the needle valve is expanded, and in this instance, the spout amount at the time of pulling the trigger to the maximum can be changed by controlling the moving-backward stroke of the needle valve in a regulated manner. Specifically, even in a state where the trigger is pulled to the maximum, it is possible to adjust the bead width by controlling the position of the needle valve in a regulated manner from a position for a large width to a position for a small width. Consequently, it is possible to conduct uniform application in a predetermined bead width irrespective of the skill of an operator.

The present invention further comprises an orifice member for reducing the area of the flow which is provided in a sealer passage in the downstream of the valve seat.

With the provision of the orifice member for reducing the area of the flow, it is possible to absorb the pulsating pressure variation, and it is possible to keep the application uniform at certain pressure even in a case of a very small bead width. Incidentally, it is preferable to replace the orifice member depending on a desired width. For this purpose, the orifice member is allowed to be mounted and removed easily, and plural kinds of orifice members having a different caliber are prepared.

In addition to the tapered portion having a tapered end which is provided at the tip of the needle valve, the present invention further comprises a ball portion to be brought into contact with or be separated from the valve seat which is provided at the back of the tapered portion.

With the provision of the tapered portion, it is possible to control a drastic increase of the spout amount at the time of starting to pull the trigger. In addition, with the provision of the ball portion, it is possible to block the hole of the valve seat quickly. Consequently, cut of the sealer can be improved, and thereby the sealer can be prevented from being left in a state of string at the final stage of the application.

### EFFECT OF THE INVENTION

According to the present invention, with the provision of the controlling member for controlling the moving-backward strokes of the needle valve in a regulated manner, and the tapered portion at the tip of the needle valve, it is possible to control a drastic increase of the spout amount at the time of starting to pull the trigger, and it is also possible to adjust the position of the needle valve in a regulated manner from a position for a large bead width to a position for a small bead width in a state where the trigger is pulled to the maximum. Consequently, it is possible to conduct uniform application in a predetermined bead width irrespective of the skill of an operator such as fine adjustment of the trigger operation amount, adjustment of the moving velocity of the sealer gun, or the like.

With the provision of the tapered portion, it is possible to control a drastic increase of the spout amount at the time of starting to pull the trigger. In addition, with the provision of the ball portion to be brought into contact or be separated from the valve seat at the back of the tapered portion, it is possible to block the hole of the valve seat quickly. Consequently, cut of the sealer at the final stage of the application can be improved, and thereby the sealer can be prevented from being left in a state of string. Also, in the case of the tapered portion alone, since the tapered portion repeatedly moves while rubbing against the hole of the valve seat, the valve seat and the tapered portion are easily worn out. However, with the provision of the ball portion, wear-out of the needle valve can be delayed, and thus the sealer can be prevented from leaking out due to wear-out of the needle valve.

### BRIEF DESCRIPTION OF THE INVENTION

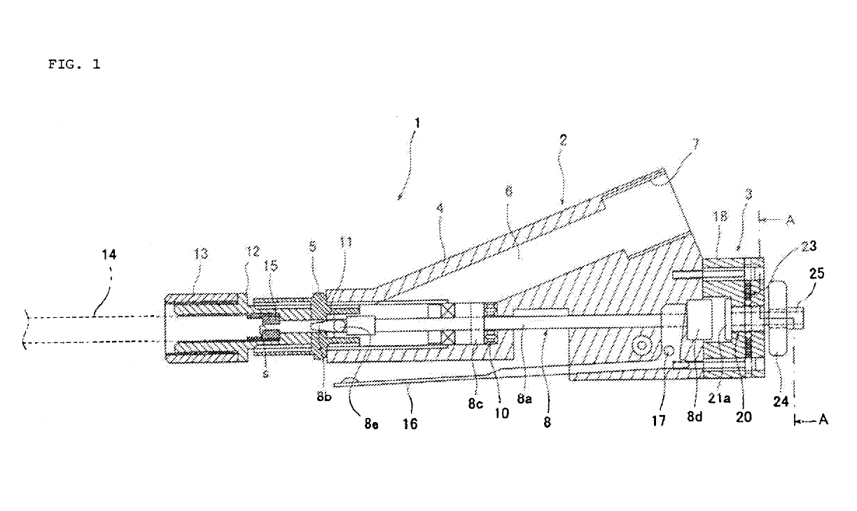

FIG. 1 is a cross-sectional view of a sealer gun according to the present invention;

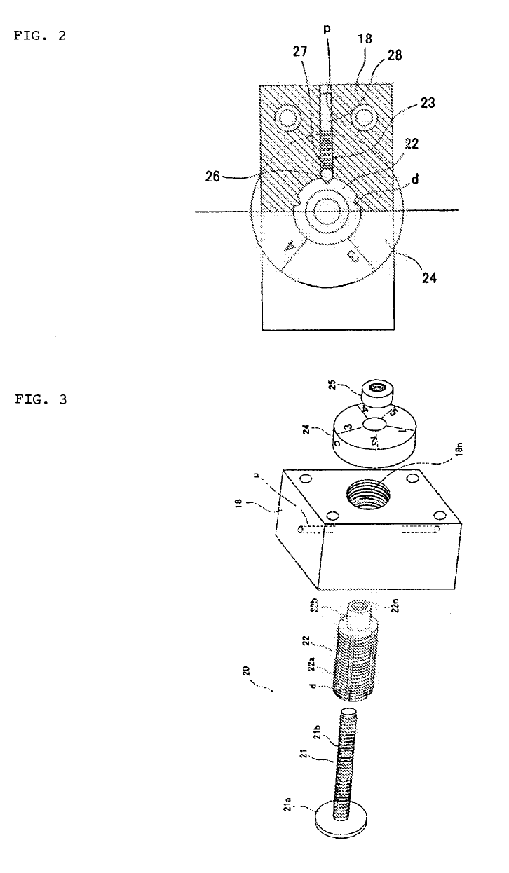

FIG. 2 is a cross-sectional view taken along line A-A of FIG. 1;

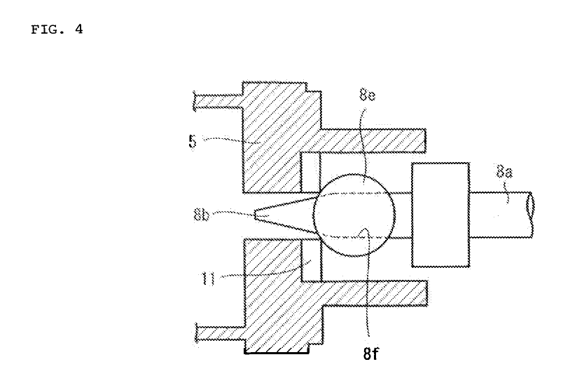

FIG. 3 is an exploded perspective view of a notch portion; and

FIG. 4 is an enlarged view of a ball portion provided at the tip of a needle valve.

### BEST MODE FOR CARRYING OUT THE INVENTION

Preferred embodiments of the present invention will now be described with reference to the accompanying drawings. FIG. 1 is a cross-sectional view of a sealer gun according to the present invention, FIG. 2 is a cross-sectional view taken along line A-A of FIG. 1, FIG. 3 is an exploded perspective view of a notch portion, and FIG. 4 is an enlarged view of a ball portion provided at the tip of a needle valve.

According to a sealer gun 1 of the present invention, even an operator having no expert skill can set a bead width of an applied sealer to be a desired one, and conduct uniform application from the initial stage to the final stage. As shown in FIG. 1, the sealer gun 1 comprises a gun body 2, and a notch portion 3 which is a controlling member.

The substantially central portion of the gun body 2 forms a grip portion 4. A nozzle 5 is provided at the tip of the gun body 2, and a sealer feeding passage 6 is connected to the nozzle 5. A connecting portion 7 to which a sealer feeding hose is connected is provided in the opening of the sealer feeding passage 6.

A needle valve 8 is comprised of a valve stem 8a in the center, a tapered portion 8b at the tip, a spring receiving portion 8c in the intermediate area, a large-diameter portion 8d on the base side, and a ball portion 8e as shown in FIG. 4. The tapered portion 8b has a shape which tapers forward. In the substantially central portion of the ball portion 8e, a penetrating hole 8f is formed in a longitudinal direction of the valve stem 8a, and the ball portion 8e having a spherical shape is engaged with the tip side of the valve stem 8a through the penetrating hole 8f at the back of the tapered portion 8b. Also, a spring 10 for pushing the needle valve 8 forward is provided at the back of the spring receiving portion 8c.

A valve seat 11 is provided in the inside of the nozzle 5 on the base side, and the ball portion 8e of the needle valve 8 can be brought into contact with the valve seat 11. When the ball portion 8e of the needle valve 8 is brought into contact with the hole of the valve seat 11, the sealer passage is blocked, and when the ball portion 8e of the needle valve 8 is separated, the sealer passage is opened. Since the needle valve 8 is pushed forward by the spring 10, the ball portion 8e is brought into contact with the hole of the valve seat 11 in its initial state, and thus the sealer passage is blocked.

A sleeve 12 can be mounted in front of the nozzle 5, and a nozzle pipe 14 can be fixed in front of the sleeve 12 by a fastening nut 13. An orifice member 15 is provided inside the sleeve 12, which has a reducing portion S having a smaller diameter than the hole diameter of the valve seat 11.

With the provision of the orifice member 15, the pulsating pressure variation of the spouted sealer can be absorbed.

A trigger 16 for operating the spout of the sealer is provided on the side of the grip portion 4. The trigger 16 is supported by a pivotal axis 17 such that the trigger 16 can be swung. When the trigger 16 is operated by gripping, the base portion thereof pushes the large-diameter portion 8d of the needle valve 8 backward, and the needle valve 8 is moved backward.

As mentioned above, before the trigger 16 is operated, the needle valve 8 is pushed forward by the spring 10, and the ball portion 8e is brought into contact with the hole of the valve seat 11, so that the sealer passage is blocked. However, when the trigger 16 is operated, the needle valve 8 moves backward by strokes, and the sealer passage is opened, so that the sealer is spouted. In this instance, the pressure of the spouted sealer can be kept uniform by the reducing portion S of the orifice member 15 which is located in the downstream of the valve seat 11.

When the trigger 16 is operated by gripping, the base portion thereof pushes the large-diameter portion 8d of the needle valve 8 backward, and thereby the needle valve 8 moves backward. In this instance, as the amount of the moving-backward stroke increases, the gap between the valve seat 11 and the tapered portion 8b of the needle valve 8 is expanded, and thus a drastic increase of the spout amount at the time of starting to pull the trigger 16 can be controlled.

When the operation of the trigger 16 is stopped, the needle valve 8 is pushed forward by the force of the spring 10, and the ball portion 8e of the needle valve 8 is brought into contact with the hole of the valve seat 11 in a planar manner so as to block the hole of the valve seat 11 quickly. Specifically, in the case of the tapered portion at the tip of the needle valve 8 alone, as the amount of the moving-forward stroke increases, the gap of the tapered portion 8b of the needle valve 8 with respect to the opening area of the valve seat 11 is gradually reduced, and the sealer is spouted until the tapered portion 8b is brought into contact with the valve seat 11 completely (linear contact). However, in addition to the tapered portion at the tip of the needle valve 8, with the provision of the ball portion 8e at the back of the tapered portion, although the cross-sectional area of the tapered portion 8b of the needle valve 8 with respect to the opening area of the valve seat 11 is gradually increased, and the gap is gradually reduced at the initial stage, the cross-sectional area is drastically increased due to the ball portion 8e, so that the hole of the valve seat 11 can be blocked quickly and the spout of the sealer can be stopped securely.

Next, the structure of the notch portion 3 (controlling member) will be explained.

The notch portion 3 which controls the moving-backward amount of the needle valve 8 (the operation amount of the trigger 16) in a regulated manner is formed unitarily with the base portion of the gun body 2. Specifically, the notch portion 3 is comprised of a case 18 which is fixed to the base portion of the gun body 2, a position-adjusting member 20 which passes through the center of the case 18 and projects backward, and a position-determining mechanism 23 which is engaged with an external tubular screw 22 so as to determine the position of the position-adjusting member 20.

The position-adjusting member 20, also shown in FIG. 3, is comprised of an internal screw 21 which is engaged with a screw hole 22n of the external tubular screw 22 and has a large-diameter portion 21a and a screw portion 21b, an adjusting knob 24 which is engaged with a small-diameter portion 22b of the external tubular screw 22, and a nut 25 for preventing the adjusting knob 24 from being disengaged, which is engaged with the tip of the internal screw 21. All of them are to be united with each other. Also, a screw portion 22a of the external tubular screw 22 is engaged with a screw hole 18n of the case 18. When the adjusting knob 24 is rotated, the position-adjusting member 20 moves back and forth by predetermined strokes with respect to the case 18. The adjusting knob 24 is provided with a scale which corresponds to the amount of the strokes of the position-adjusting member 20. With this structure, a desired bead width can be achieved only by setting the adjusting knob 24 to an appropriate position of the scale.

The length of the tapered portion 8b at the tip of the needle valve 8 is at least more than the moving strokes of the position-adjusting member 20. When the position-adjusting member 20 is moved, the gap between the valve seat 11 and the tapered portion 8b is varied corresponding thereto.

A plurality of grooves D are formed on the outer surface of the screw portion 22a of the external tubular screw 22 in the axial direction, and the interval of the grooves D is uniform in the radial direction. A ball 26 of the position-determining mechanism 23, which is mentioned below, can enter the grooves D and be engaged therewith.

As shown in FIGS. 1 and 2, the position-determining mechanism 23 is comprised of two screw holes P which are provided in the upper portion and the lower portion of the case 18, the ball 26 which is mounted inside the screw hole P, a spring 27 which pushes the ball 26 inward, and a fixed screw 28. When the external tubular screw 22 is rotated by the adjusting knob 24, the rotation can be controlled in a regulated manner so as to be moderate because the ball 26 enters the groove D at intervals.

The external tubular screw 22 and the internal screw 21 may be formed unitarily. However, they can be formed separately. By forming separately, it becomes easy to manufacture, and the cost can be reduced because the external tubular screw 22 alone can be replaced even if the screw portion 22a of the external tubular screw 22 is worn out.

In operation, when the width of applying a sealer needs to be adjusted in the sealer gun 1, the adjusting knob 24 is rotated such that the position-adjusting member 20 can be set in a desired position. With this, even if the trigger 16 is operated to the maximum, the large-diameter portion 8d of the needle valve 8 comes into contact with the large-diameter portion 21 a of the internal screw 21, and thereby the moving-backward position thereof is controlled physically. Accordingly, the gap between the tapered portion 8b of the needle valve 8 and the valve seat 11 is controlled in a predetermined quantity, and the spout amount of the sealer can be controlled.

Additionally, the tapered portion 8b of the needle valve 8 serves to control an increase of the spout amount at the time of starting the application.

With the provision of the orifice member 15 in the downstream of the valve seat 11, even if there is pulsating pressure variation in the pump for the sealer, such variation can be absorbed, so that the spout of the sealer can be conducted at uniform pressure. Consequently, it is possible to keep the bead width uniform.

When the application width needs to be changed, the position of the position-adjusting member 20 is adjusted in a regulated manner forward or backward by the adjusting knob 24. Specifically, in order to decrease the application width, the position-adjusting member 20 is moved forward, and thereby the amount of the moving-backward stroke of the needle valve 8 is decreased. In order to increase the application width, the position-adjusting member 20 is moved backward, and thereby the amount of the moving-backward stroke of the needle valve 9 is increased.

Also, if needed, the orifice member 15 may be replaced by one having an appropriate caliber to a desired application width. By doing so, it is possible to keep the bead width more uniform.

The present invention should not be limited to the above-mentioned embodiment. Modifications having substantially the same structure and effect as the subject matter of the present invention are within the technical scope of the present invention.

For example, the concrete structure of the notch portion 3 for controlling the moving-backward strokes of the needle valve is optional. Also, the number or the like of the grooves D formed on the external tubular screw 22 is just an example. By adjusting the intervals of the grooves D, a more accurate stroke amount can be achieved.

### INDUSTRIAL APPLICABILITY

As mentioned above, according to the present invention, in the sealer gun in which a sealer is spouted from the gap between the valve seat and the needle valve by moving the needle valve backward, the controlling member is provided so as to control the moving-backward strokes of the needle valve in a regulated manner. With the provision of the controlling member, the sealer can be applied in a desired bead width. An operator only needs to operate the trigger to the maximum, and thus no expert skill is needed. Also, with the provision of the orifice member, the pulsating pressure variation is absorbed, and uniform application can be achieved.

1. A sealer gun comprising:
a trigger;
a needle valve; and
a valve seat,
wherein the needle valve is moved backward by predetermined strokes by operating the trigger so as to form a gap between the valve seat and the needle valve, so that a sealer is spouted from the gap, and
wherein the sealer gun further comprises a tapered potion having a tapered end that is provided at a tip of the needle valve, and a ball portion to be brought into contact with or be separated from the valve seat that is provided at a back of the tapered portion.

2. The sealer gun according to claim 1, wherein the sealer gun further comprises an orifice member for reducing an area of flow provided in a sealer passage downstream of the valve seat.

3. The sealer gun according to claim 1, wherein the sealer gun further comprises a controlling member for controlling the moving-backward stroke of the needle valve in a regulated manner.

4. The sealer gun according to claim 2, wherein the sealer gun further comprises a controlling member for controlling the moving-backward stroke of the needle valve in a regulated manner.
